(19) United States
(12) Patent Application Publication
(10) Pub. No.: US 2015/0010350 A1
(43) Pub. Date: Jan. 8, 2015

(54) Coupling Mechanism

(71) Applicant: James Hardie Technology Limited, Dublin (IE)

(72) Inventor: Brian A. Emanuel, Baraboo, WI (US)

(21) Appl. No.: 14/317,275

(22) Filed: Jun. 27, 2014

Related U.S. Application Data
(60) Provisional application No. 61/842,092, filed on Jul. 2, 2013.

(51) Int. Cl. F16B 5/00; B29C 70/52; E04B 1/74

(52) U.S. Cl. CPC F16B 5/0004; E04B 1/74; B29C 70/523; B29L 2031/776
USPC 403/364; 264/177.18; 264/171.1

(57) ABSTRACT

A coupling mechanism comprising at least two complementary shaped connecting members and a spline member wherein the at least two complementary shaped connecting members are configured to engage with each other and spline member is configured to secure the at least two connecting members together when the at least two complementary shaped connecting members are in an engaged configuration.

### CROSS-REFERENCE TO RELATED APPLICATIONS

This application claims priority to U.S. provisional application Ser. No. 61/842,092, filed Jul. 2, 2013, the entire contents of which is incorporated herein by reference.

### BACKGROUND OF THE INVENTION

1. Technical Field

The present disclosure generally relates to a mechanism for coupling adjacent components together and more particularly to a mechanism for coupling adjacent modular components together.

2. Background Art

It is well known that coupling mechanisms typically use mechanical fasteners such as nuts, bolts, rivets or clamps to secure adjacent components together. It is also well known to use such mechanisms to secure adjacent similarly configured sections together to form a modular system, for example, a highway sign panel system. Such a system has been exemplified in U.S. Pat. No. 3,150,455 to Indorf. U.S. Pat. No. 3,150,455 discloses a seam-locking system that comprises a rearwardly projecting retainer portion that forms a recess on the reverse side of the panel. The recess portion of the rearwardly projecting retainer portion receives a locking element that is slidable within the recess. This is then slid to the appropriate location and secured in place using conventional mechanical fastening mechanisms. Traditional mechanical fasteners are used to secure these various components of the highway sign panel system in place.

It is also known to incorporate interlocking mechanisms between adjacent sections or components in modular systems to seat adjacent sections together in closer alignment. Typically, such systems also require the use of additional mechanical fastening means or reinforcing means, to adequately secure adjacent sections or components together. The use of mechanical fastening means is often regarded as being disadvantageous as the components of the fastening means are small and are often cumbersome during installation. Furthermore, in the instance where a mechanical fastening means is used in a modular system, usually there are items projecting from the surfaces of the components of the modular system which are aesthetically displeasing and a potential hazard.

The present invention seeks to improve upon the prior art by providing an aesthetically pleasing mechanism for coupling adjacent components together without fasteners that project from the modular components exterior surface.

### SUMMARY OF THE INVENTION

It is therefore an object of the present invention to provide a discrete coupling mechanism suitable for securing adjacent component sections together.

For the purposes of this specification, the term ‘comprise’ shall have an inclusive meaning. Thus it is understood that it should be taken to mean an inclusion of not only the listed components it directly references, but also non specified components. Accordingly, the term ‘comprise’ is to be attributable with as broad an interpretation as possible and this rationale should also be used when the terms comprised′ and/or ‘comprising’ are used.

Further aspects or embodiments of the present invention will become apparent from the ensuing description which is given by way of example only.

In one embodiment of the invention, the present disclosure provides a coupling mechanism comprising at least two complementary shaped connecting members and a spline member wherein the at least two complementary shaped connecting members are configured to engage with each other and the spline member is configured to secure the at least two connecting members together when the at least two complementary shaped connecting members are in an engaged configuration.

Conveniently each of the connecting members are provided with one or more complementary shaped projecting members wherein the complementary shaped projecting members are designed to interact with each other when the at least two complementary shaped connecting members are in an engaged configuration. In one embodiment the complementary shaped projecting members are configured to form an engaging portion and a receptacle wherein the engaging portion of a complementary shaped projecting member of a first of two complementary shaped connecting members inserts into and engages with the receptacle of a corresponding complementary shaped projecting member of a second of the two complementary shaped connecting members.

In a further embodiment of the invention, the at least two complementary shaped connecting members are configured to be secured to at least two similarly configured panels such that the at least two complementary shaped connecting members are used to connect two or more similarly configured panels together in a side by side or a stacked arrangement.

In a further embodiment of the invention, the at least two complementary shaped connecting members are secured to opposing surfaces of a panel wherein the panel comprises a first face and a second face which are spaced apart to define a core area of predetermined thickness intermediate the first face and the second face and a peripheral edge member, wherein the peripheral edge member extends around the core area between the first and second faces such that the at least two complementary shaped connecting members are positioned on two opposing surfaces of the peripheral edge member.

In one embodiment of the invention the at least two complementary shaped connecting members are integrally formed with the peripheral edge member of the panel. In a further embodiment of the invention the at least two complementary shaped connecting members project from the peripheral edge member of the panel such that the at least two complementary shaped connecting members are spaced apart from each other in the same plane and are substantially parallel to each other.

Accordingly, in one embodiment of the invention, at least two panels comprising the at least two complementary shaped connecting members on opposing sides of the peripheral edge member are coupled together such that the first of the at least two connecting members of one panel is juxtaposed with the second of the at least two connecting members of another panel and the at least two complementary shaped connecting members are in an engaged configuration and secured together using the spline member to form a modular system. Conveniently, in a further embodiment of the modular system of the invention, the at least two connecting members form a planar surface which is in alignment with and continuous to the first face of each panel. In a further embodiment, the at least two connecting members form a planar surface which is in alignment with and continuous to the second face of each panel.

It should be understood that the panels can be coupled in any configuration, for example in a side by side configuration wherein one panel is positioned beside another panel, or a stacked configuration, wherein one panel is positioned on top of another panel or in a combination of side by side and stacked configurations.

In a further embodiment of the invention, the at least two complementary shaped connecting members are provided with one or more projecting members which are configured to engage with each other and to form one or more interstitial cavities intermediate two adjacent panels. Conveniently the spline member is configured to complement the shape of at least one of the interstitial cavities formed when the at least two complementary shaped connecting members are in an engaged configuration. In use the spline member is inserted into the interstitial cavity to secure the at least two complementary shaped connecting members together. The advantage of the spline member of the invention is that it prevents the at least two complementary shaped connecting members from disengaging with each other. Optionally the edges of the projecting members and/or the spline member are shaped, for example, angled or rounded to ensure that the components of the coupling mechanism fit together easily.

In a further embodiment of the invention the core area of the panel further comprises a core material. It should be understood that any suitable material known to a person skilled in the art could also be used as the core material. In one embodiment of the invention the core material is an insulation material, for example, a foam material, such as expanded polystyrene. Accordingly, in one embodiment of the invention, the panels are insulation panels linked together by coupling mechanism of the invention to form a modular insulation system. Such an insulation modular system could be used, for example, to form the surround of a refrigerated area in a building or on a transport vehicle.

It is to be understood that different embodiments of the panel are envisaged. For example in one embodiment of the invention, each panel comprises separable components arranged and secured together to form a panel. In further embodiments some or all of the components of the panel are formed in a continuous arrangement with one or more of the other components of the panel so as to form either larger discrete sections or a complete unit.

In a further embodiment of the invention there is provided a corner coupling mechanism which facilitates the placement of panels of the invention at an angle to each other. Conveniently, the corner coupling mechanism comprises two substantially ‘U’ shaped channels positioned at an angle relative to each other wherein the substantially ‘U’ shaped channels are sized and shaped to receive the panels of the invention. In one embodiment of the invention the ‘U’-shaped channels are resiliently biased to securely receive panels such that an external force must be applied to remove each panel from the substantially ‘U’-shaped channel. In a further embodiment of the invention the substantially ‘U’-shaped channels are optionally also provided with additional adhesive materials to secure the panels into position, for example, adhesive transfer tape or closed cell foam tape. In a further embodiment of the invention, the substantially U-shaped channels are provided with a resiliently biased insert, wherein the resiliently biased insert is provided with a flexible stop which can deform on insertion into the U-shaped channel between the wall of the channel and the panel and then move into a rest position abutting the wall of the channel thereby preventing removal of the resiliently biased insert without the application of an external force.

The panels and coupling mechanism of the invention can be made from any suitable material known to a person skilled in the art. In one embodiment of the invention, the panels and coupling mechanism of the invention are preferably made from a resiliently deformable material using techniques known to the person skilled in the art, for example pultruded fibreglass reinforced plastic, extruded plastics or metal alloys such as aluminium. Accordingly, In one embodiment of the invention, the present disclosure provides a method for making a panel comprising components of the coupling mechanism of the invention comprising the steps of;
(a) pulling glass fibres through resin such that the glass fibres are saturated with the resin;
(b) pulling the pulled glass fibres through a forming die; and
(c) heating the forming die to cure the resin such that a rigid profile is formed that corresponds to the shape of the forming die.

In a further embodiment of the invention, the present disclosure provides a forming die and mandrel configured to provide a panel profile for the panel of the invention wherein the forming die and mandrel is configured such that the shape of the at least two connecting members respectively are formed as part of the panel.

In a further embodiment of the invention, the method of the invention further comprises the steps of;
(d) injecting a suitable core material into the rigid profile whilst in the forming die such that the core material adheres to the inner wall of the rigid profile.

In a further embodiment of the invention the forming die and mandrel are further provided with injector tubes. Optionally the injector tubes are surrounded by injector tube flanges which are provided to centre the injector tube within the centre of mandrel. The injector tubes are used to insert the appropriate core material in the core area of panel It is to be understood that the number of injector tubes used in the forming die and mandrel is determined by the overall size of the panel and can be altered by the person skilled in the art.

The advantage of having the core material is that it adds additional structural strength to the panel of the invention. In a further embodiment of the invention the core material is an insulating material such as for example, expanded polystyrene. In this embodiment of the invention, the panel comprising the rigid profile and core material is formed in a continuous pultrusion process and the elongate structure is cut at the appropriate location to divide the structure into sections or panels. Accordingly, the rigid profile and the core material are completely cured by the time the elongate structure is cut.

### BRIEF DESCRIPTION OF THE DRAWINGS

For more complete understanding of the features and advantages of the disclosures described herein, reference is made to a description of the disclosure along with accompanying figures, wherein;

FIG. 1 is a perspective view of a panel comprising interlocking components of the coupling mechanism according to one embodiment of the invention;

FIG. 2 is an exploded perspective view of the panel of FIG. 1;

FIG. 3 is a perspective view of a modular system comprising interlocking components of the coupling mechanism according to one embodiment of the invention interlocked at Section A of the drawing;

FIG. 4 is a top view of the modular system of FIG. 3 showing the interlocked portion at Section B of the drawing;

FIGS. 5a and 5b are enlarged end views of the interlocking components located on opposing sides of the panel of FIG. 1;

FIG. 6 is an enlarged sectional top view of the interlocking components of Section B of FIG. 4;

FIG. 7 is an enlarged sectional perspective view of the interlocking components of Section A of FIG. 3;

FIG. 8 is a sectional view of a second embodiment of the coupling mechanism according to the invention;

FIG. 9a is a perspective view of the spline of the coupling mechanism according to one embodiment of the invention;

FIG. 9b is a front view of the spline of FIG. 9;

FIG. 9c is an end view of the spline of FIG. 9;

FIG. 10 is a cross-sectional top view of a corner assembly of a modular system using the coupling mechanism according to one embodiment of the invention;

FIG. 11 is a cross-sectional end view of the forming die for an insulated panel comprising the coupling mechanism according to one embodiment of the invention; and

FIG. 12 is a flow chart of a method of manufacturing a panel comprising interlocking components of the coupling mechanism according to one embodiment of the invention.

### DETAILED DESCRIPTION OF THE DRAWINGS

Referring now to the drawings in general, there are shown multiple embodiments of the coupling mechanism 20, 22, 70 according to the present invention. The various embodiments of the coupling mechanism 20, 22, 70 of the present invention are shown in relation to two different embodiments of panels 10, 50, both of which may form part of a modular system 100 wherein the coupling mechanism 20, 22, 70 of the invention is used to couple similarly configured panels 10, 50 together.

### I. First Embodiment

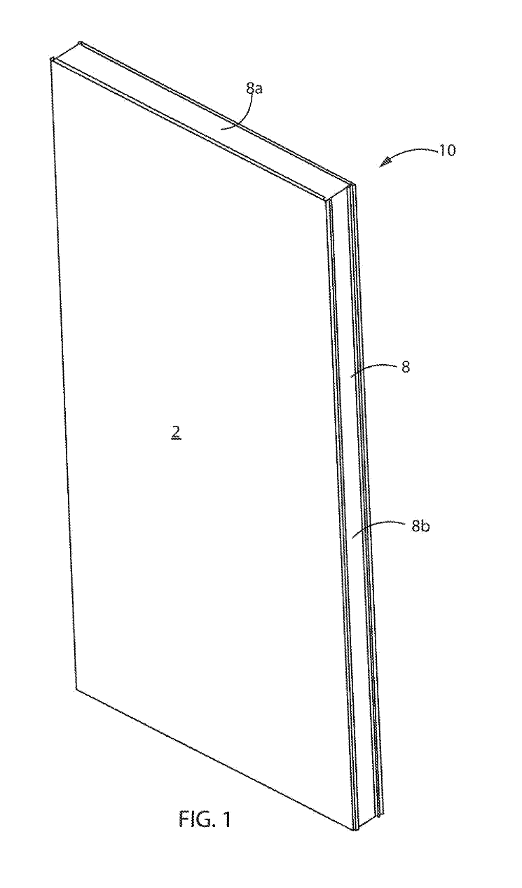

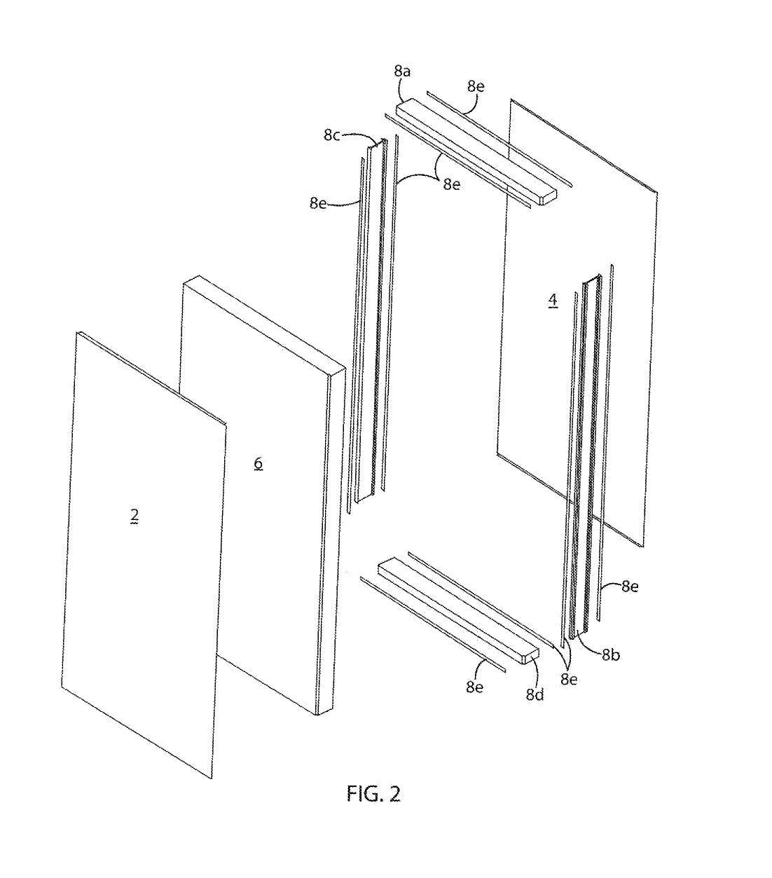

Referring specifically to FIGS. 1 and 2, panel 10 comprises a first face 2 and a second face 4 which are spaced apart to define a core area (not shown) of predetermined thickness intermediate to the first face 2 and the second face 4. In the embodiment shown the core or intermediate area is filled with core material 6. The core material 6 may be formed of a foam material. In the example shown, foam core material 6 is in the form of insulation material, for example expanded polystyrene. Accordingly, in one embodiment of the invention panels 10 are insulation panels linked together by coupling mechanism 20 of the invention to form a modular insulation system 100. Such a modular insulation system 100 could be used, for example, to form the surround of a refrigerated area in a building or on a transport vehicle. It should be understood that any suitable material known to a person skilled in the art could also be used as the core material 6. It should also be understood that in other embodiments of the invention the core area could be either partially or fully filled with core material 6 or alternatively remain empty.

Still referring to FIGS. 1 and 2, peripheral edge member 8 of the panel 10 extends around the core area between the first and second faces 2 and 4 respectively. Peripheral edge member 8 comprises rail members 8a and 8d and stile members 8b and 8c, whereby the rail members 8a and 8d are positioned on two opposing sides of the core area and the stile members 8b and 8c are positioned on the other of two opposing sides of the core area. Generally, the rail members 8a correspond to the horizontal members of the panel 10 and the stile members 8b and 8c correspond to the vertical members of the panel 10. The first and second faces 2 and 4 of panel 10 together with the rail and stile members 8a, 8b, 8c, 8d of peripheral edge member 8 surround and enclose core material 6. In the embodiment shown, rail members 8a and 8d are formed from foam material that can be the same or different foam material to that of core foam material 6.

It is to be understood that different embodiments of the panel are considered within the scope of the present invention. For example in the first embodiment as shown in FIGS. 1 and 2, the panel 10 comprises separable components arranged and secured together to form panel 10. Each of rail members 8a, 8d and stile members 8b, 8c may also have adhesive transfer tape 8e attached to their elongate edges to further secure and bond the components of panel 10 together. In further embodiments some or all of the components of the panel 10 are formed in a continuous arrangement with one or more of the other components of panel 10 so as to form either larger discrete sections or a complete unit.

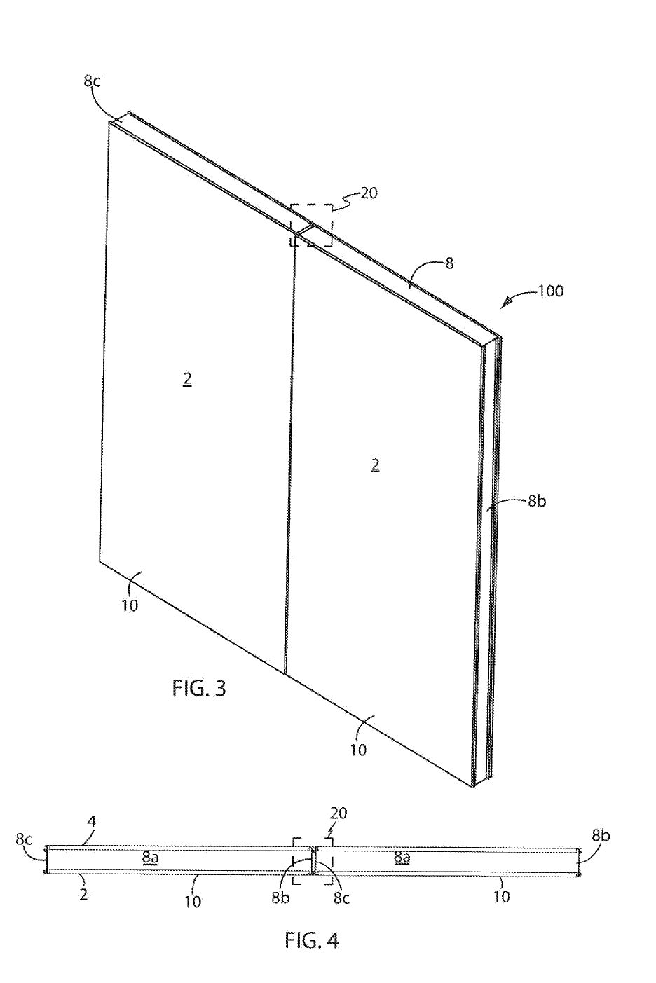

In the illustrated embodiment shown in FIGS. 1 and 2, stile members 8b and 8c further comprise complementary shaped male and female connecting members respectively; wherein, stile member 8b is defined as the female connecting member and stile member 8c is defined as the male connecting member. The complementary shaped male and female connecting members 8b and Sc each form part of the coupling mechanism 20 as outlined below. In this arrangement, the panels of the invention can be coupled to one and other in a side by side arrangement as illustrated in FIG. 3. It should also be understood that panels 10 could also be coupled in other configurations, for example in a stacked configuration, wherein one panel is positioned on top of another panel or in a combination of side by side and stacked configurations. Accordingly, in further embodiments of the invention rail members 8a and 8d also further comprise complementary shaped male and female connecting members.

Referring now to FIGS. 3 to 7 and 9, there is shown a modular system 100 comprising panels 10 which are joined together using coupling mechanism 20. Coupling mechanism 20 comprises female connecting member 8b, male connecting member 8c and spline member 12, whereby male and female connecting members 8c and 8b are provided with one or more complementary shaped projecting members designed to engage with each other. Spline member 12 secures male and female connecting members 8c and 8b together when in an engaged configuration.

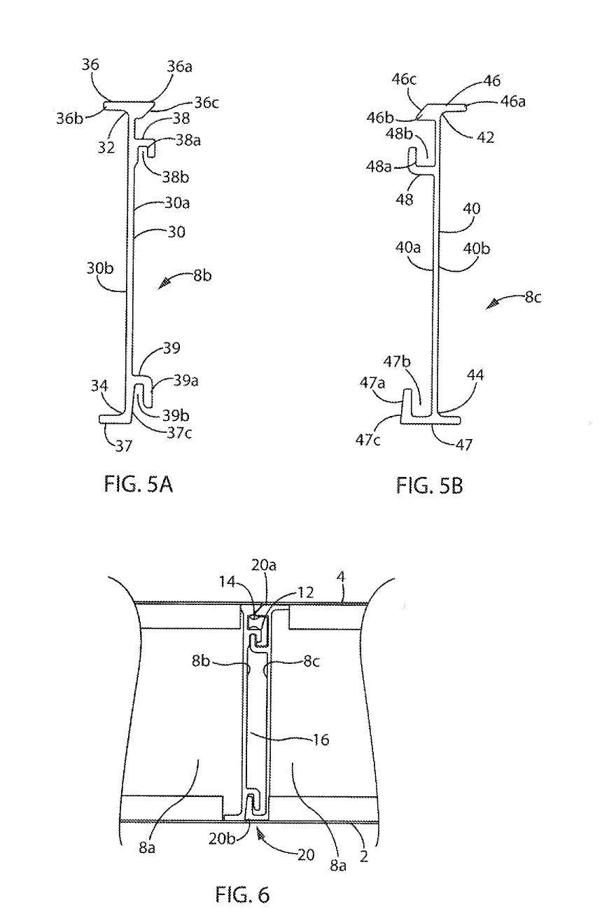

Referring specifically to FIG. 5a, female connecting member 8b comprises a web 30 which may be generally planar and includes a first face 30a and a second face 30b. A first end 32 and a second end 34 are disposed on opposing ends of the web 30; and a plurality of projecting members 36, 37, 38 and 39 extend outwardly from the web 30. The opposing end projecting members 36 and 37 extend substantially orthogonally from the first end 32 and second end 34 of the web 30 respectively such that the positioning of projecting members 36 and 37 relative to the web 30 forms a substantially shape. Side projecting members 38 and 39 extend from the first face 30a of web 30 such that each projecting member 38 and 39 forms an outwardly extending engaging portion 38a and 39a and a receptacle 38b and 39b respectively relative to the first face 30a of web 30. It is to be understood that in other embodiments of the invention that projecting members 36, 37, 38 and 39 can be adapted to suit the profile of the panel as determined by the person skilled in the art.

Referring now to FIG. 5b, male connecting member 8c comprises a web 40 which may include a first face 40a and a second face 40b. A first end 42 and a second end 44 are disposed on opposing ends of the web 40; and a plurality of projecting members 46, 47, and 48 extend outwardly from the web 40. The opposing end projecting members 46 and 47 extend substantially orthogonally from the first end 42 and second end 44 of the web 40 such that the positioning of projecting members 46 and 47 relative to the web 40 forms a substantially ‘I’ shape. End projecting member 47 further comprises outwardly extending extension member 47a which extends substantially orthogonally from end projecting member 47 such that it is spaced apart and parallel to the web 40 forming a receptacle 47b intermediate to the web 40 and extension member 47a. Side projecting member 48 extends from the first face 40a of the web 40 such that it forms an outwardly extending engaging portion 48a which extends substantially orthogonally from side projecting member 48 such that it is spaced apart and parallel to the web 40 forming and a receptacle 48b relative to the first face 40a of the web 40. The second side 40b is adjacent the core area of the panel 10. It is to be understood that in other embodiments of the invention end projecting members 46, 47 and 48 can be adapted to suit the profile of the panel as determined by the person skilled in the art.

End projecting members 36, 37, 46 and 47 of the male and female connecting member 8c, 8b respectively are sized and shaped such that when the male and female connecting members 8c and 8b are brought into alignment to form connecting member 20 they sit together with a minimal interstitial gap between the two sections as shown in FIG. 6. In the embodiment shown female end projecting member 36 of connecting member 8b is configured such that it has one end 36a which has a larger surface area, mass and/or density than the opposing end 36b and is also provided with edge 36c configured to engage or mate with the corresponding edge of male connecting member 8c. In the illustrated embodiment of the invention, shown in FIG. 5a, edge 36c is shown as being angled or chamfered. The corresponding male end projecting member 46 of connecting member 8c is also configured such that it has one end 46b which has a lager surface area, mass and/or density than the opposing end 46a. Edge member 46c is angled to complement the angled or chamfered edge 36c of female projecting member 36 of complementary connecting member 8b, such that when the complementary male and female connecting members 8c and 8b seat together, end projecting members 36 and 46 form a substantially planar surface as shown in FIG. 6. In a similar way, corresponding end projecting members 37 and 47 are also provided with angled surfaces 37c and 47c which are of complementary shape such that they also form a substantially planar surface when the complementary male and female connecting members 8c and 8b seat together also shown in FIG. 6.

As shown in the drawings, the at least two complementary male and female connecting members 8c and 8b seat together whereby the engaging portion 38a on the connecting member 8b of female side projecting member 38 is seated within receptacle 48b on the connecting member 8c of male side projecting member 48, and the engaging portion 48a on the connecting member 8c of male side projecting member 48 is seated within receptacle 38b on the connecting member 8b of female side projecting member 38. Concurrently, the engaging portion 39a on the connecting member 8b of female side projecting member 39 is seated within receptacle 47b on the connecting member 8c of male end projecting member 47, and the engaging portion 47a on the connecting member 8c of male end projecting member 47 is seated within receptacle 39b on the connecting member 8b of female side projecting member 39.

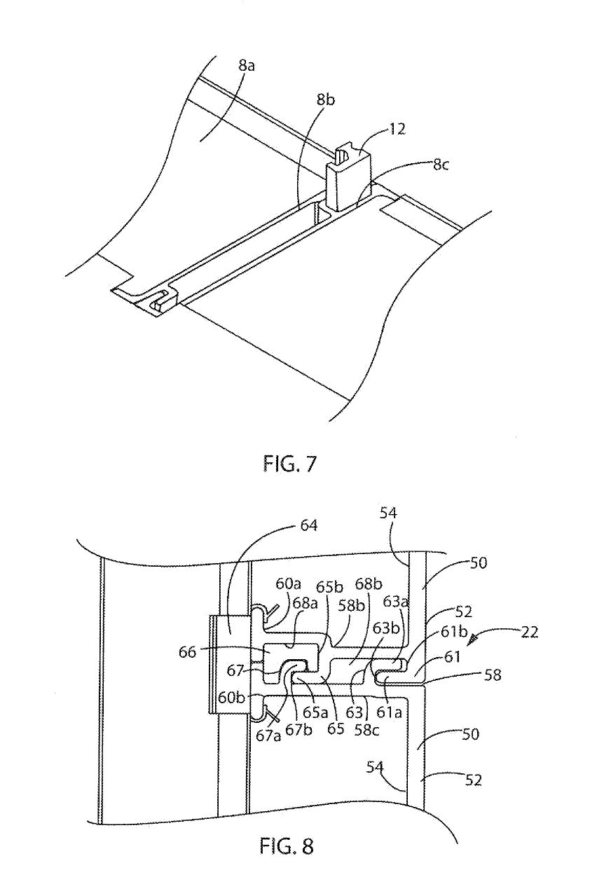

Referring now to FIGS. 6 and 7, there are shown enlarged views of the coupling mechanism 20, as were previously shown in FIGS. 3 and 4. Coupling mechanism 20 is positioned intermediate two adjacent similarly configured panels 10. In this instance the male and female complementary connecting members 8c and 8b of the coupling mechanism 20 are integrally formed with panels 10 whereby the complementary male and female connecting members 8c and 8b correspond to the stile members of peripheral edge member 8 positioned on opposing surfaces of respective panels 10. Accordingly, panels 10 are arranged in the modular system such that the male connecting member 8c of one panel 10 is juxtaposed with a female complementary connecting member 8b of another panel 10 when placed in a side by side arrangement. When connected, the complementary male and female connecting members 8c and 8b are seated together and form opposing outer facing planar surfaces 20a and 20b which are in alignment with and continuous to the first face 2 and second face 4 of panels 10 respectively. The side projecting members 38, 39 and 48 of the respective male and female connecting members 8c and 8b are engaged with each other as outlined above forming interstitial cavities 14 and 16 intermediate panels 10.

Still referring to FIG. 6, generally, spline 12 is an elongate structure which adopts a substantially ‘C-shape’ in cross section. The length of spline 12 usually corresponds to the length of the male and female connecting members 8c and 8b respectively, however it is to be understood that the spline 12 could be of any desired length as required by the application. In the example shown, spline 12 is configured to complement the shape of interstitial cavity 14 formed adjacent to the end projecting members 36, 46 of the two complementary shaped connecting members 8b, 8c respectively.

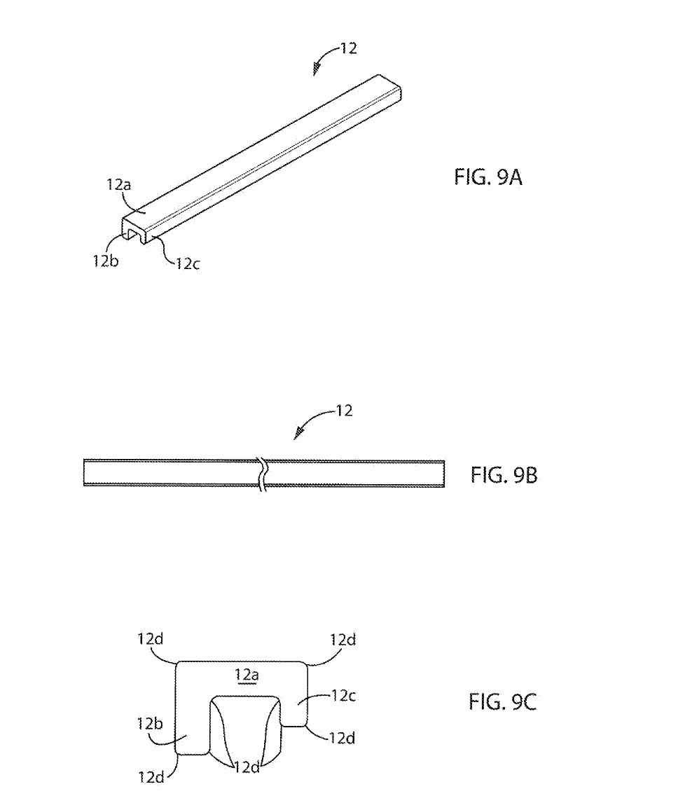

Referring now to FIGS. 9a to 9c, spline 12 is shown in further detail, comprising a base member 12a having two projecting legs 12b and 12c. In this embodiment of the invention projecting legs 12b and 12c are of unequal length. Spline edges 12d have been rounded or bevelled to facilitate insertion of spline 12 into the interstitial cavity 14 as shown in FIG. 7. As a result of the shape of the spline 12 relative to the corresponding shape of the interstitial cavity 14, when spline 12 is inserted into interstitial cavity 14 the two complementary male and female connecting members 8c and 8b are securely locked together preventing separation of either of the male and female connecting member 8c and 8b from each other.

Although not illustrated, it is considered well within the scope of the present invention that the interstitial cavity 16 may also be used to alter the thermal conductive properties of the coupling mechanism 20 as desired by the person skilled in the art. For example, in one embodiment, interstitial cavity 16 could be filled with insulation material to improve the insulating properties of a modular insulation system 100.

### II. Second Embodiment

Referring now to FIG. 8, there is shown an alternative embodiment of the coupling mechanism of the invention, shown at 22. In this embodiment, the two complementary male and female connecting members shown at 58b and 58c are functionally similar to the connecting members 8b and 8c, as described above. The two complementary connecting members 58c and 58b project from opposing ends of adjacent panels 50; wherein, each panel 50 comprises a first face 52 and a second face 54 which are spaced apart to define a core area of predetermined thickness intermediate the first face 52 and the second face 54. A peripheral edge member 58 extends around the core area between the first and second faces 52 and 54 respectively. The first connecting member 58c extends from the peripheral edge member 58 at a first end of the panel 50, while the second connecting member 58b extends from the peripheral edge member 58 at an opposing second end of the panel 50.

As with the prior embodiment, the two complementary male and female connecting members 58c and 58b are configured to form a plurality of complementary shaped engaging portions and receptacles which when brought into engagement with each other form an interstitial cavity 68a into which a spline 66 is inserted to securely lock the two complementary male and female connecting members 58c and 58b together. Specifically, an engaging portion 61a on an end projecting member 61 of the connecting member 58b is seated within a receptacle 63b on a side projecting member 63 of connecting member 58c. In addition, an engaging portion 63a of side projecting member 63 is seated within a receptacle 61b of end projecting member 61. Similarly and concurrently, near the opposing end of the connecting members 58b, 58c, an engaging portion 65a on a side projecting member 65 of the connecting member 58b is seated within a receptacle 67b on a side projecting member 67 of connecting member 58c, and an engaging portion 67a on an end projecting member 67 of the connecting member 58c is seated within a receptacle 65b of a side projecting member 65 on the connecting member 58b.

When connected in this manner, as shown in FIG. 8, end projecting member 60b of connecting member 58c is configured such that it engages or mates with the corresponding end projecting member 60a of connecting member 58b, and forms a substantially planar surface as shown in FIG. 6.

Furthermore, when the two complementary connecting members 58c and 58b are seated together such that their respective end projecting members 60a, 60b are coplanar and the first face 52 of the first panel 50 is in alignment with and continuous to the first face 52 of the second panel 50, the respective connecting members 58c and 58b will form interstitial cavities 68a and 68b. The spline 66 is then inserted into interstitial cavity 68a, or alternatively interstitial cavity 68b, in a manner described above to securely lock the two complementary connecting members 58c and 58b together.

Additionally, as shown in FIG. 8, end projecting members 60a and 60b may be secured to an ‘I’ beam 62 or any other structural element by use of a connector 64 configured to receive the end projecting members 60a, 60b therein.

### III. Third Embodiment

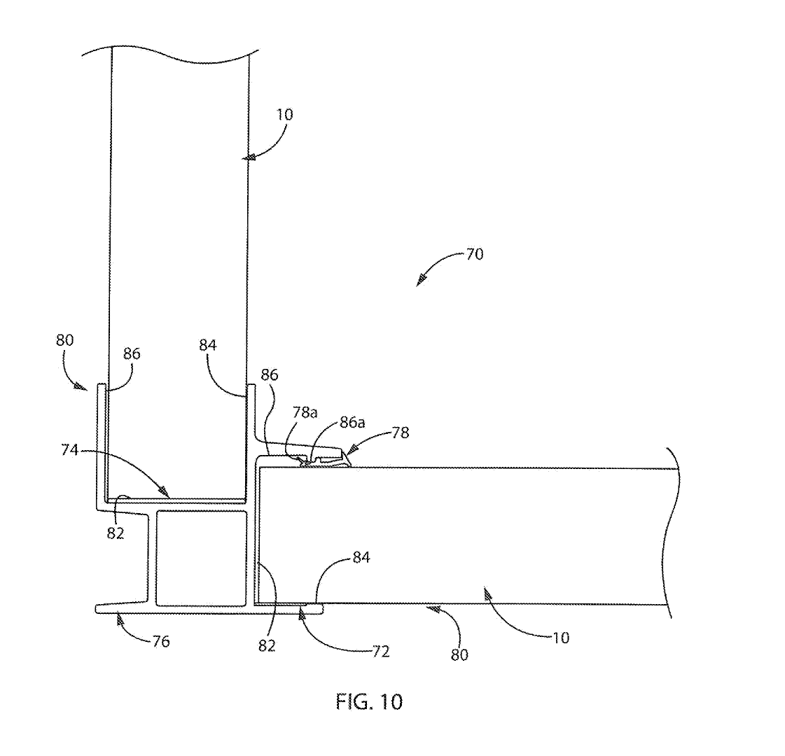

Turning now to FIG. 10, a corner coupling mechanism 70 is shown which facilitates the placement of panels 10 of the invention at an angle relative to each other. In the example shown the panels 10 are placed at right angles (90°) to each other, however it is to be understood that the corner coupling mechanism 70 can be adapted to accommodate other relevant angles as determined by a person skilled in the art. Corner coupling mechanism 70 comprises two substantially ‘U’ shaped channels 80 positioned at right angles (90°) to each other which are sized and shaped to receive panels 10. The shaped panels 80 are also provided with a rearward supporting extension member 76. In the illustrated embodiment, the ‘U’ shaped channels 80 have a rear wall 82 and two parallel arms 84, 86 extending substantially perpendicular to the rear wall 82. The arms 84, 86 are resiliently biased to securely receive panels 10 such that the application of an external force directed away from rear wall 82 will be required to remove panels 10 from each of the substantially ‘U’ shaped channels 80. In one embodiment, the ‘U’ shaped channels 80 are also provided with an additional securing feature to secure the panels 10 into position, for example, adhesive transfer tape or closed cell foam tape 72, located along the inner facing surface of the rear wall 82, or adhesive transfer tape or closed cell foam tape 74, located along the inner facing surface of arms 84, 86. In yet another alternative embodiment the additional securing feature may be a resiliently biased insert 78. In the example shown, resiliently biased insert 78 is provided with a flexible stop 78a which can deform on insertion into the U-shaped channel 80 between the arm 86 of the channel 80 and the panel 10. When the resiliently biased insert 78 is in position the flexible stop 78a will move into a rest position abutting a projection 86a from the arm 86 of the channel 80. Flexible stop 78a will prevent removal of the resiliently biased insert 78 without the application of an external force.

The panels 10, 50 and coupling mechanism 20, 22, 70 of the invention can be made from any suitable material known to a person skilled in the art. In one embodiment of the invention, the panels 10, 50 and coupling mechanism 20, 22, 70 of the invention may be made from a resiliently deformable material using techniques known to the person skilled in the art, for example pultruded fibreglass reinforced plastic, extruded plastics or metal alloys such as aluminium.

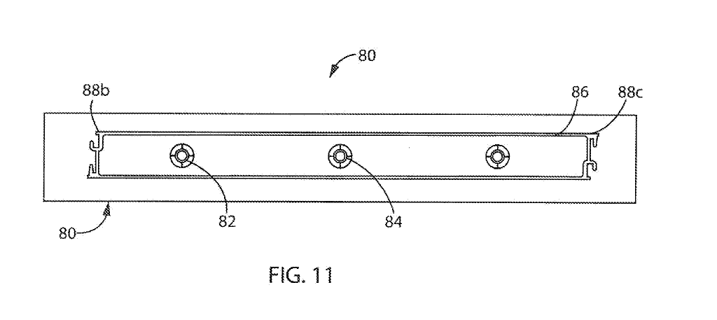

In a further embodiment of the invention panel 10 may be formed using a pultruded fibreglass reinforced glass that is injected with an appropriate core material 6 such as, for example, expanded polystyrene foam. Referring now to FIG. 11, there is shown a forming die 80 of the invention. The forming die 80 of the invention is provided with a mandrel 86 such that the forming die 80 and mandrel 86 are configured to provide a panel profile for panel 10. In this embodiment of the invention, the configuration of the forming die 80 and mandrel 86 is such that the shape of the male and female complementary shaped connecting members 8c and 8b respectively are formed as part of the panel 10. The shapes of the two complementary shaped male and female connecting members 8c and 8b respectively are located at male and female corresponding die sides 88c and 88b of the die 80 respectively.

Forming die 80 and mandrel 86 may further be provided with injector tubes 84. Injector tubes 84 are used to insert the appropriate core material 6 in the core area of panel 10. Representatively, three injector tubes 84 may be provided in forming die 80 and mandrel 86 of FIG. 11. It is to be understood that the number of injector tubes 84 used in the forming die 80 and mandrel 86 is determined by the overall size of the panel and can be altered by a person skilled in the art. Injector tubes 84 are surrounded by injector tube flanges 82 which are provided to centre the injector tube 84 within the centre of mandrel 86.

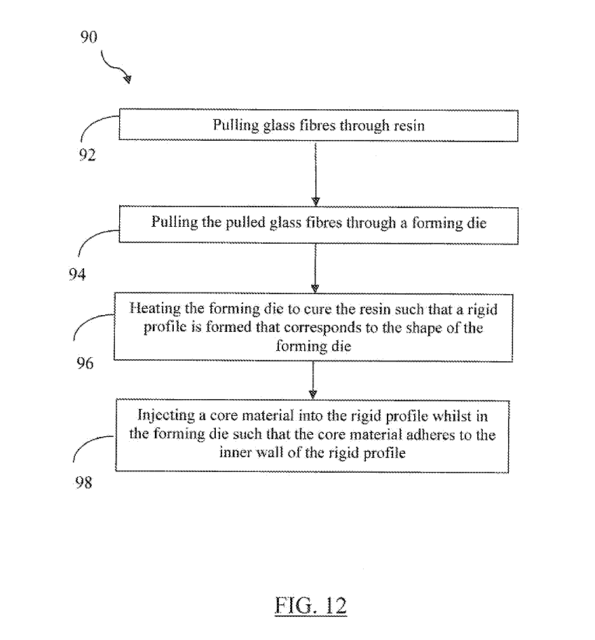

Generally, as shown in the flow chart of FIG. 12, the method 90 of forming the panels 10 in accordance with a pultrusion process comprises the steps of:

(a) pulling glass fibres through resin such that the glass fibres are saturated with the resin, at block 92;

(b) pulling the pulled glass fibres through a forming die, at block 94; and

(c) heating the forming the to cure the resin such that a rigid profile is formed that corresponds to the shape of the forming die, at block 96.

In this embodiment of the invention, the method 90 of the invention may further comprise the steps of;

(d) injecting a suitable core material into the rigid profile whilst in the forming die such that the core material adheres to the inner wall of the rigid profile, at block 98.

Providing the core material 6 at block 98 during the manufacturing method 90 provides additional structural strength to the panel of the invention. In another embodiment of the invention the core material 6 is an insulating material such as, for example, expanded polystyrene. In this embodiment of the invention, panel 10 comprising the rigid profile and core material 6 are formed in a continuous pultrusion process, in accordance with method 90, and the elongate structure is cut at the appropriate location to divide the structure into sections or panels 10, 50. Accordingly, the rigid profile and the core material 6 are completely cured by the time the individual panels 10, 50 are cut.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It is also understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

I claim:

1. A coupling mechanism comprising at least two complementary shaped connecting members and a spline member wherein the at least two complementary shaped connecting members are configured to engage with each other and the spline member is configured to secure the at least two complementary shaped connecting members together when the at least two complementary shaped connecting members are in an engaged configuration.

2. The coupling mechanism as claimed in claim 1, wherein each of the complementary shaped connecting members are provided with one or more complementary shaped projecting members.

3. The coupling mechanism as claimed in claim 2, wherein the at least two complementary shaped connecting members are configured to be secured to at least two similarly configured panels such that the at least two complementary shaped connecting members are used to connect two or more similarly configured panels together in a side by side or a stacked arrangement.

4. The coupling mechanism as claimed in claim 3, wherein the at least two complementary shaped connecting members are secured to opposing surfaces of one of the at least two similarly configured panels, the one of the at least two similarly configured panels comprises a first face and a second face which are spaced apart to define a core area of predetermined thickness intermediate to the first face and the second face and a peripheral edge member extends around the core area between the first and second faces wherein the at least two complementary shaped connecting members are positioned on two opposing surfaces of the peripheral edge member.

5. The coupling mechanism as claimed in claim 4, wherein the at least two complementary shaped connecting members are integrally formed with the peripheral edge member of the panel.

6. The coupling mechanism as claimed in claim 3, wherein the at least two complementary shaped connecting members project from the peripheral edge member of the panel such that the at least two complementary shaped connecting members are spaced apart from each other in the same plane and are substantially parallel to each other.

7. The coupling mechanism as claimed in claim 3, wherein the at least two similarly configured panels each comprising the at least two complementary shaped connecting members are coupled together such that the first of the at least two connecting members of one panel is juxtaposed with the second of the at least two connecting member of another panel and the complementary shaped projecting members of each connecting member are in an engaged configuration and the at least two complementary shaped connecting members are secured together using the spline member.

8. The coupling mechanism as claimed in claim 7, wherein the engaged complementary shaped projecting members are configured to form one or more interstitial cavities intermediate the at least two complementary shaped connecting members.

9. The coupling mechanism as claimed in claim 8, wherein the spline member is configured to complement the shape of at least one of the interstitial cavities intermediate the at least two complementary shaped connecting members

10. The coupling mechanism as claimed in claim 3, wherein the core areas of the at least two similarly configured panels further comprises a core material.

11. The coupling mechanism as claimed in claim 10, wherein the core material is an insulation material.

12. A coupling mechanism as claimed in claim 10, wherein the core material is foam.

13. A coupling mechanism as claimed in claim 10 wherein the core material is expanded polystyrene.

14. The coupling mechanism as claimed in claim 10, wherein the at least two similarly configured panels are insulation panels linked together by the at least two complementary shaped connecting members and the spline member to form a modular insulation system.

15. A method for making a panel comprising components of a coupling mechanism comprising the steps of;
(a) pulling glass fibres through a resin such that the glass fibres are saturated with the resin;
(b) pulling the resin saturated glass fibres through a forming die, wherein the forming die has a first side configured to form a first connecting members and a second side configured to form a second connecting member that is complementary to and configured to mate with the first connecting member; and
(c) heating the forming die to cure the resin such that a rigid profile is formed that corresponds to the shape of the forming die.

16. 14. The method for making a panel as claimed in claim 12, further comprising the step of;
(d) injecting a suitable core material into the rigid profile between the first connecting member and the second connecting member whilst in the forming die such that the core material adheres to an inner wall of the rigid profile.

17. The method for making a panel as claimed in claim 13 further comprising a mandrel, wherein the forming die and mandrel further comprise injector tubes.

18. The method for making a panel as claimed in claim 14, wherein the forming die and mandrel further comprise injector tube flanges.

19. A modular insulation system, the system comprising;
a coupling mechanism comprising at least a first and a second complementary shaped connecting member and a spline member wherein the first and second complementary shaped connecting members are configured to engage with each other and the spline member is configured to secure the first and second complementary shaped connecting members together when the first and second complementary shaped connecting members are in an engaged configuration;
a first and second panel, each panel having a first face and a second face which are spaced apart to define a core area of predetermined thickness intermediate to the first face and the second face and a peripheral edge member extending around the core area between the first and second faces wherein at least one first and at least one second complementary shaped connecting member is positioned on opposing surfaces of the peripheral edge member.

20. The modular insulation system of claim 19, wherein the first complementary shaped connecting member of the first panel is configured to be secured to the second complementary shaped connecting member of the second panel such that the first and second complementary shaped connecting members are used to connect the first and second panels together in a side by side or a stacked arrangement.
